(19) United States
(12) Patent Application Publication
(10) Pub. No.: US 2023/0139542 A1
(43) Pub. Date: May 4, 2023

(54) DEVICE FOR CONTROLLING THE EXHAUST OF A VEHICLE PNEUMATIC SYSTEM

(71) Applicant: Jose D. Ortega, Bakersfield, CA (US)

(72) Inventor: Jose D. Ortega, Bakersfield, CA (US)

(21) Appl. No.: 17/515,529

(22) Filed: Oct. 31, 2021

(51) Int. Cl. F15B 21/00; F15B 21/041

(52) U.S. Cl. CPC F15B 21/005; F15B 21/041; B60T 15/027

(57) ABSTRACT

The present invention provides a device for controlling the exhaust of a vehicle's pneumatic system, herein after referred to as the exhaust controller. The exhaust controller may comprise at least one intake opening operable to receive compressed exhaust air via a pneumatic line and direct it towards at least one exhaust opening operable to redirect and effectively neutralize the force of the exiting air such that prevents the formation of a dust cloud. The intake opening may further comprise an adjustable connector operable to interface with a pneumatic line and create an adjustable seal with the intake opening and the pneumatic line. The pneumatic line may be an exhaust valve of the pneumatic system or airline tubing in fluid communication with the exhaust valve. The exhaust valve may be part of an air compressor, air reservoir, air brake, or an air suspension system.

### FIELD OF THE INVENTION

The present invention relates generally a device for controlling the exhaust air of a pneumatic system. More particularly, the present invention provides a device operable to impede, redirect and/or utilize exhaust air of a vehicle's pneumatic system.

### BACKGROUND OF THE INVENTION

Pneumatic systems are systems that utilize compressed air or other inert gasses to provide power to different components of the system. Such systems can be found in several different industries but are especially prominent in the braking and suspension systems of heavy vehicles for a variety of reasons. Vehicular air brakes have proven to be safer and more reliable than their hydraulic counter parts by having a safety mechanism that may still bring the vehicle to a stop in the event of a pneumatic system failure. Similarly, vehicular air suspension systems are more durable and effective at dampening noise and vibration compared to their spring-based counterparts. The superior reduction in noise and vibration not only enable an air suspension system to provide a more comfortable ride but also increases the general durability of the vehicle since other components don't receive as much vibrational force during operation. As a result, most semi-trucks, tractors, and other heavy vehicles are equipped with pneumatic/air-based braking and suspension systems, to provide the optimal balance of reliability, safety, and cost efficiency.

However, such pneumatic based braking and suspension systems require compressed air tanks that must be drained regularly for proper maintenance. This may be problematic under certain circumstances since the exhaust/drain valve of these systems are typically oriented vertically toward the ground, or in a manner that otherwise risks creating a cloud of dirt, debris, and other atmospheric particles (i.e. dust cloud) if drained at the wrong location. This cloud of debris can not only damage other components of the vehicle but also cause irritation to anyone in the immediate vicinity. Thus, a device operable to control the exhaust of the pneumatic system is needed.

### SUMMARY OF THE INVENTION

The present invention provides a device for controlling the exhaust of a vehicle's pneumatic system, herein after referred to as the exhaust controller. The exhaust controller may comprise at least one intake opening operable to receive compressed exhaust gas (e.g., air) via a pneumatic line and direct it towards at least one exhaust opening operable to redirect and effectively neutralize the force of the exiting gas such that prevents the formation of a dust cloud. The exhaust controller may also be configured such that the purged gas flow is directed in one or more directions to displace any dust that may result from the motion of the vehicle. For example, the exhaust controller may be fitted on a truck and when the truck comes to a stop over a dusty surface, the exhaust controller may direct air brake system exhaust to perimeter areas of the vehicle to blow away any dust placed in the air column. The intake opening may further comprise an adjustable connector operable to interface with a pneumatic line and create an adjustable seal with the intake opening and the pneumatic line. The pneumatic line may be an exhaust valve of the pneumatic system or airline tubing in fluid communication with the exhaust valve. The exhaust valve may be part of an air compressor, air reservoir, air brake, or an air suspension system.

The exhaust controller may have a body with generally any shape, comprising at least one opening for the intake opening and at least one exhaust opening operable to redirect the exiting air. In some embodiments, the exhaust controller may have a cylindrical body with a protruding hollow stem comprising an inferior opening and a superior opening that comprises the intake opening. In such embodiments, the intake opening, located at the peak of the stem, may be operable to receive exhaust air via a pneumatic line. The inferior opening then provides a passage for the exhaust air to disburse through exhaust opening. The intake opening may have any shape or size that is complimentary to a standard pneumatic line such that the intake opening may easily interface with the pneumatic line. For example, the intake opening may have an elliptical or circular shape, with a diameter in the range of about 0.25 inch to about 3 in. In some embodiments, the intake opening may be circular with a diameter of about 1.5 in. For another example, the intake opening may comprise threading complimentary to the threading of a standard pneumatic line.

In some embodiments, the exhaust controller, may be comprised of may be made of at least one type of plastic, including polymethyl methacrylate (PMMA), polycarbonate (PC), polyethylene (PE), polypropylene (PP), polyethylene terephthalate (PETE or PET), polyvinyl chloride (PVC), acrylonitrile-butadiene-styrene (ABS), or any material (e.g. steel, wood, glass) substantially rigid enough to withstand the standard pressure within a compressed air tank of a vehicles pneumatic system. For example, the exhaust controller may be comprised of PVC and capable of withstanding pressures in the range of about 100 psi to about 130 psi.

In some embodiments, the exhaust controller may comprise one or more exhaust openings. The exhaust opening is oriented such that the exhaust air is redirected to ensure the exiting air is no longer directed at the ground and debris on a floor below the pneumatic system, preventing the exhaust air from creating a dust cloud. Providing at least one exhaust opening, preferably much larger than the intake opening, and/or a plurality of exhaust openings, enable the exhaust controller to greatly diminish the velocity of the exiting air, further limiting the potential of creating a dust cloud. The exhaust opening(s) may have a circular, elliptical, or polygonal shape, wherein in the size of the opening is proportional to the size of the intake opening by a proportional factor. In some embodiments, proportional factor may be a cross-sectional area ratio that is determined by dividing the cross-sectional area of the exhaust opening with the cross-sectional area of the intake opening. For example, a proportional factor of 3 would correspond with the cross-sectional area of the exhaust opening being about 3 times the cross-sectional area of the intake opening. The proportional factor may have a magnitude in range of about 2 to 5, or any magnitude operable to effectively neutralize the force of the air exiting the device without constricting or obstructing components of the vehicle/pneumatic system. For example, the exhaust controller device may have an intake opening with a cross-sectional area of approximately 1.75 sq. in. (corresponding to a diameter of about 1.5 in.) and have a cross-sectional area of approximately 7 sq. in. (corresponding to a diameter of about 3 in.), or a proportional factor of about 4. In some embodiments, proportional factor may be a measurement ratio that is determined by dividing a measurement of the exhaust opening with the analogous measurement of the intake opening. For example, a proportional factor of 3 may correspond with the diameter of the exhaust opening being about 3 times the diameter of the intake opening. The exhaust controller may have two or more exhaust openings (e.g., 2, 3, 4, 5, 6, or more exhaust openings) positioned at various relative angles, e.g., to perform a dust clearing function. For example, the exhaust controller may have two exhaust openings located at opposite ends of the exhaust controller such that it can clear dust on each lateral side of a vehicle. In other embodiments, the exhaust controller may include four exhaust openings with two exhaust openings angled obliquely toward each lateral side of a vehicle.

In some embodiments, the exhaust controller may also provide a dusting effect with the exhaust air, wherein the compressed air exiting exhaust openings has sufficient force purge dust, debris and other small particles from other components of the vehicle. In such embodiments, the exhaust controller may be placed in a predetermined location with the exhaust opening oriented in a predetermined manner facing other components of the vehicle. In such embodiments, the magnitude of the proportional factor may be substantially smaller than the aforementioned ranges or about 1 (i.e. the size of the intake opening is the same as the exhaust opening).

An exemplary exhaust controller, may further comprise an adjustable connecter operable to create an air-tight seal between the intake opening and the pneumatic line. In some embodiments, the adjustable connector may comprise a pipe fitting with hose clamps. In such embodiments, the adjustable connector may comprise an intake interface and a pneumatic line interface operable to interface with the intake opening and the pneumatic line respectively. The intake interface may further comprise a hose clamp, operable to adjust the shape/size of the intake interface to adjust the strength of the seal with the intake opening. Similarly, the pneumatic line interface may further comprise a hose clamp, operable to adjust the shape/size of the intake interface to adjust the strength of the seal with the pneumatic line. In some embodiments the shape and size of both the intake interface and pneumatic line interface may coincide with the intake opening, having an elliptical or circular shape with a diameter in the range of about 0.5 in. to about 5 in. In some embodiments, the adjustable connector may have at least one threaded interface comprised of threading complimentary to that of the intake opening and/or the pneumatic line. In some embodiments, the adjustable connector may a quick connect coupling, such as a Type T or C-style automotive pneumatic line fitting. The adjustable connector may be comprised of rubber, plastic, silicone, or any other material flexible enough to enable the connector to adjust the size and shape (i.e., stretching and constricting) without compromising the integrity of the seal.

In some embodiments, the present invention is a device for controlling exhaust air from the pneumatic system of a vehicle comprising: an intake opening operable to interface with a pneumatic line, receive compressed air via said pneumatic line, and direct it towards; at least one exhaust opening operable to redirect said compressed air. The at least one exhaust opening may comprise a first and second exhaust opening located on opposite sides of the device, such that said compressed air is redirected into two streams. The exhaust controller may comprise a hollow cylindrical body further comprising: a first end corresponding with said first exhaust opening, a second end corresponding with said second exhaust opening, a hollow stem protruding from the surface of said cylindrical body comprising a base with an inferior opening located within said hollow cylindrical body and a superior opening at the peak of said hollow stem corresponding to said intake opening. The exhaust controller may further comprise an adjustable connecter comprising intake interface and a pneumatic line interface operable adjust the seal between said intake opening and pneumatic line. The pneumatic line may be a valve or airline hose of said pneumatic system that may be located on an air compressor, air tank, air braking, or on an air suspension system. The exhaust opening may have a cross-sectional area proportional to the cross-sectional area of said intake opening by a proportional factor. The magnitude of said proportional factor may be in the range such that the exhaust controller is operable to effectively neutralize the force of air exiting said exhaust opening. The magnitude of said proportional factor may alternatively in the range such that the exhaust controller is operable to provide a dusting effect that purges dust, debris, and other small particles from the internal components of said vehicle.

In some embodiments, the present invention is an exhaust controller for controlling exhaust air from the pneumatic system of a vehicle comprising: an intake opening operable to interface with a pneumatic line, receive compressed air via said pneumatic line, and further comprising an adjustable connecter, and at least one exhaust opening operable to redirect said compressed air. The exhaust controller may have a hollow cylindrical body further comprising: a first end corresponding with said first exhaust opening, a second end corresponding with said second exhaust opening, a hollow stem protruding from the surface of said cylindrical body comprising a base with an inferior opening located within said hollow cylindrical body and a superior opening at the peak of said hollow stem corresponding to said intake opening. The adjustable connecter may further comprise intake interface and a pneumatic line interface operable adjust the seal between said intake opening and pneumatic line. The pneumatic line may be a valve or airline hose of said pneumatic system that's located on air compressing, air storing, air braking, or on an air suspension system. The cross-sectional area of said at least one exhaust opening may proportional to said intake opening, and may be in a range such that the exhaust controller is operable to effectively neutralize the force of air exiting said exhaust opening. For example, intake opening has a cross-sectional area in the range of about 0.25 sq in. to about 25 sq in. and said at least one exhaust opening has a cross sectional area in the range of about 0.5 sq in. to about 125 sq in.

Further aspects and embodiments will be apparent to those having skill in the art from the description and disclosure provided herein.

It is an object of the present invention to provide a device to control the exhaust of a vehicle's air suspension or air brake system.

It is an object of the present invention to provide a device operable to redirect and neutralize the force of exhaust air.

It is an object of the present invention to provide a device operable to utilize exhaust air from an air suspension system or air brake system to provide a dusting effect to other components of the vehicle.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a perspective view of the exhaust controller, according to an embodiment of the present invention.

FIG. 2 provides a front view of the exhaust controller, according to an embodiment of the present invention.

FIG. 3 provides a rear view of the exhaust controller, according to an embodiment of the present invention.

FIG. 4 provides a side view of the exhaust controller, according to an embodiment of the present invention.

FIG. 5 provides a side view of the exhaust controller, according to an embodiment of the present invention.

FIG. 6 provides a top view of the exhaust controller, according to an embodiment of the present invention.

FIG. 7 provides a bottom view of the exhaust controller, according to an embodiment of the present invention.

FIG. 8 provides an environmental view of the exhaust controller in use, according to an embodiment of the present invention.

FIG. 9 provides a perspective view of the exhaust controller connected to a pneumatic line, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

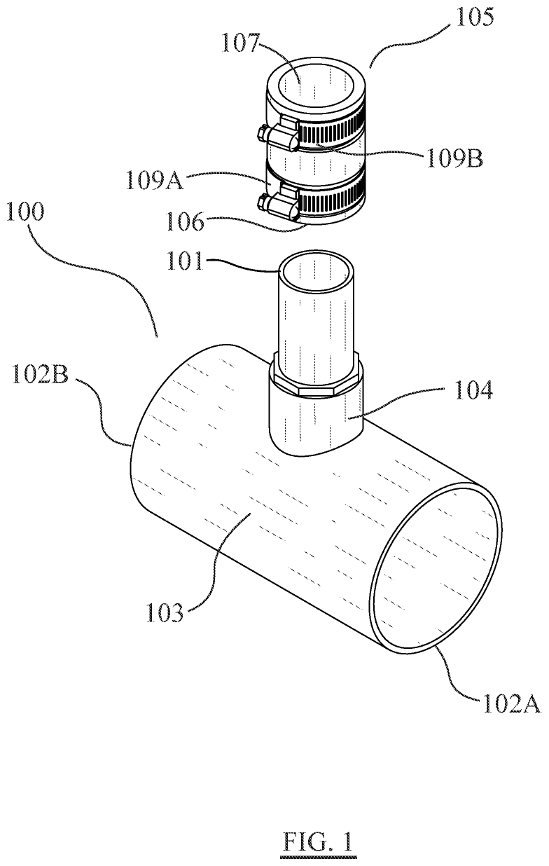

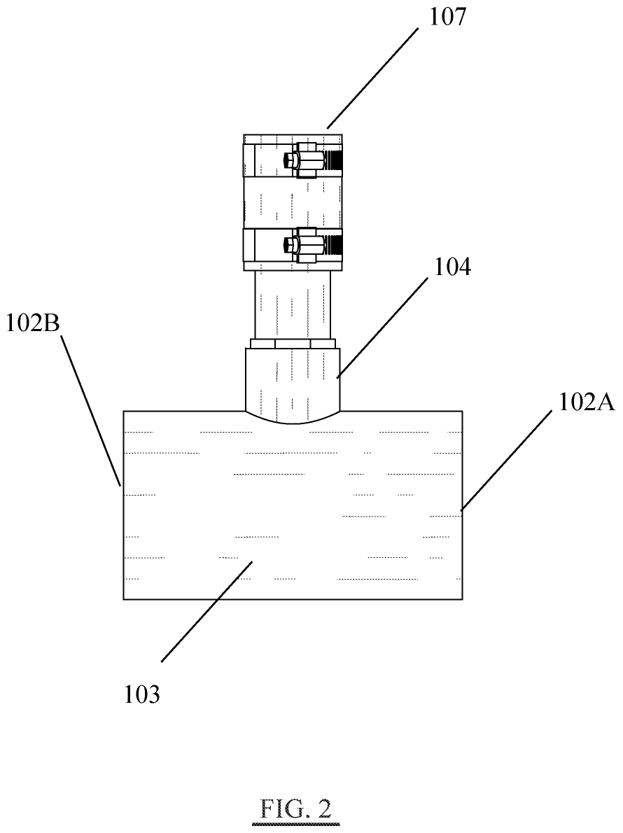

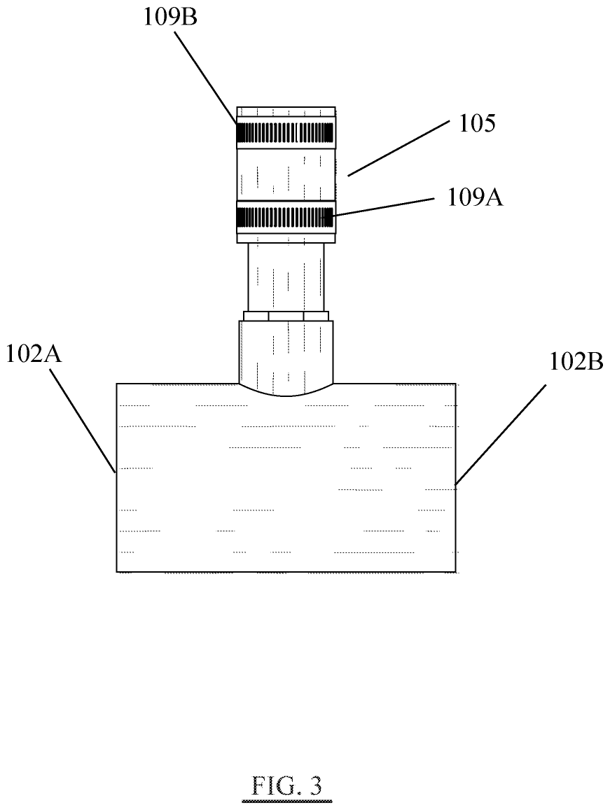

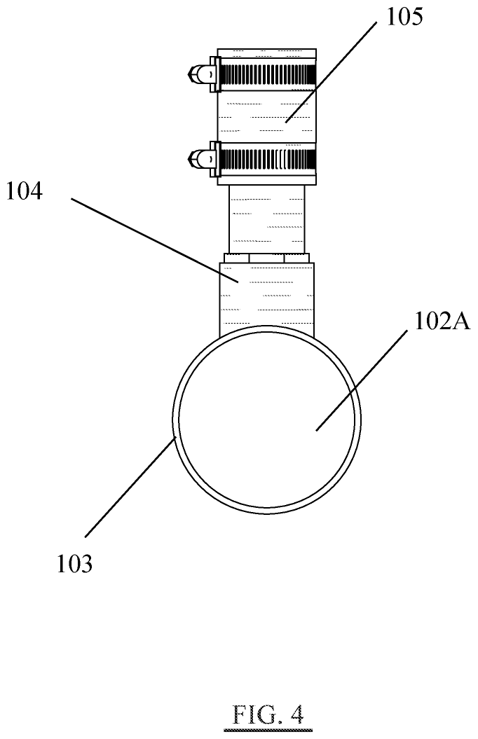

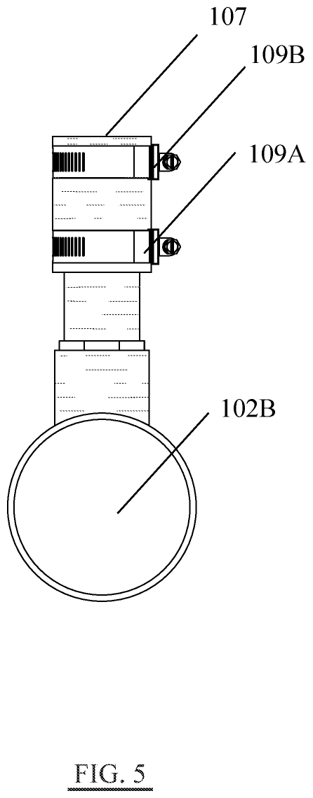

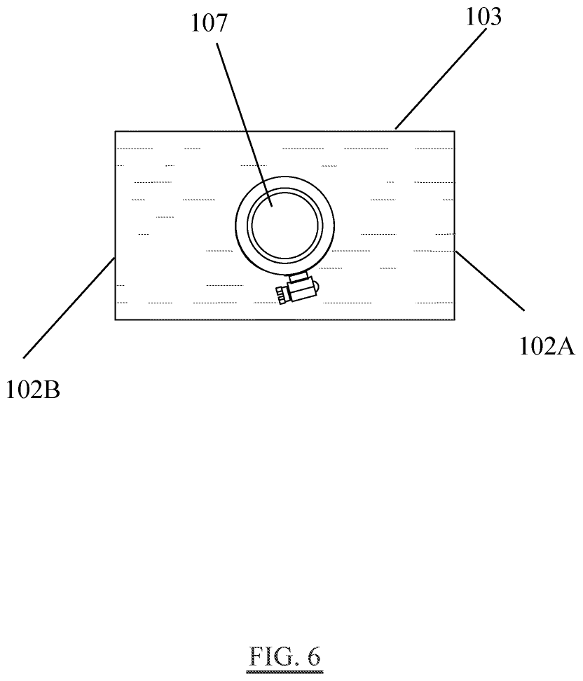

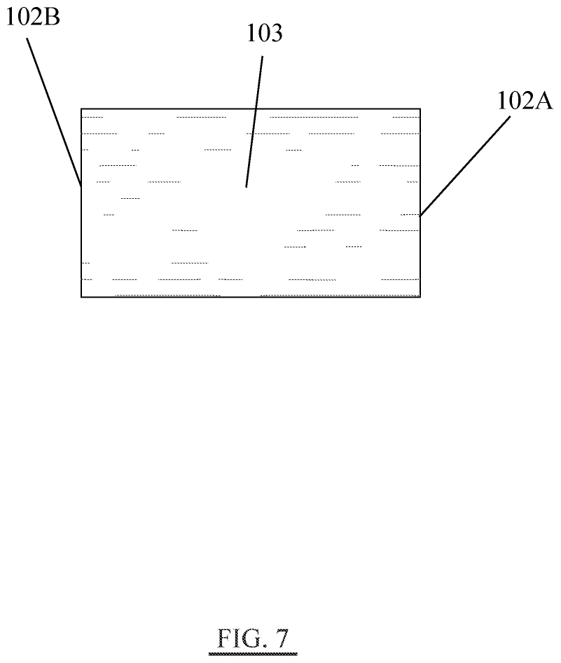

The present invention concerns a device for controlling the exhaust of a vehicle's pneumatic system. FIGS. 1-9 provide an exemplary exhaust controller device 100 according to the present invention. The exhaust controller 100 may include an intake opening 101 operable to receive compressed exhaust air via a pneumatic line 108 and direct it towards a first exhaust opening 102A and a second exhaust opening 102B. The exhaust controller may have a hollow cylindrical body 103 with a hollow stem 104 protruding therefrom. The hollow stem 104 may comprise an inferior opening located within the cylindrical body and a superior opening at the peak that corresponds with the intake opening 101. The intake opening may further comprise an adjustable connector 105 operable to interface with a pneumatic line 108 and create an adjustable seal with the intake opening 101 and pneumatic line 108.

In some embodiments, as shown in FIG. 1, the exhaust controller 100 may have a cylindrical body 103 with a protruding hollow stem 104 comprising an inferior opening and a superior opening that comprises the intake opening 101. The intake opening 101, located at the peak of the stem 104, may be operable to receive exhaust air via a pneumatic line 108. The inferior opening provides a passage for the exhaust air from the intake opening 101 to disburse through exhaust opening(s) 102. The intake opening 101 may have an elliptical or circular shape, with a diameter in the range of about 0.5 inch to about 5 in. For example, as shown in FIG. 1, the intake opening 101 may be circular with a diameter of about 1.5 in. In other embodiments the shape and size of the intake opening may be complimentary to the shape and size of the pneumatic line 108 such that the intake opening may easily interface with the pneumatic line.

In some embodiments, the exhaust controller 100, may be comprised of may be made of at least one plastic, including polymethyl methacrylate (PMMA), polycarbonate (PC), polyethylene (PE), polypropylene (PP), polyethylene terephthalate (PETE or PET), polyvinyl chloride (PVC), acrylonitrile-butadiene-styrene (ABS), or any material (e.g. steel, wood, glass) substantially rigid enough to withstand the standard pressure within a compressed air tank of a vehicles pneumatic system. For example, the exhaust controller 100 shown in FIG. 1 may be comprised of PVC and capable of withstanding pressures in the range of about 100 psi to about 130 psi.

In some embodiments, as shown in FIG. 1, the exhaust controller may comprise at comprise one or more exhaust openings 102. The exhaust opening(s) 102 may have a circular, elliptical, or polygonal shape, wherein in the size of the opening is proportional to the size of the intake opening 101. In some embodiments, proportional factor may be a cross-sectional area ratio that is determined by dividing the cross-sectional area of the exhaust opening with the cross-sectional area of the intake opening. For example, a proportional factor of 3 would correspond with the cross-sectional area of the exhaust opening 102 being about 3 times the cross-sectional area of the intake opening 101. The proportional factor may have a magnitude in range of about 2 to 5, or any magnitude operable to effectively neutralize the force of the air exiting the device 100 without constricting or obstructing components of the vehicle/pneumatic system. For example, the exhaust controller device 100 may have an intake opening with a cross-sectional area of approximately 1.75 sq. in. (corresponding to a diameter of about 1.5 in.) and have a cross-sectional area of approximately 7 sq. in. (corresponding to a diameter of about 3 in.), or a proportional factor of about 4. In some embodiments, proportional factor may be a measurement ratio that is determined by dividing a measurement of the exhaust opening with the analogous measurement of the intake opening. For example, a proportional factor of 3 may correspond with the diameter of the exhaust opening 102 being about 3 times the diameter of the intake opening 101.

In some embodiments, the exhaust controller 100 may also provide a dusting effect with the exhaust air, wherein the compressed air exiting exhaust openings 102 has sufficient force to purge dust, debris and other small particles from other components of the vehicle. In such embodiments, the exhaust controller may be placed in a predetermined location with the exhaust opening oriented in a predetermined manner facing other components of the vehicle. In such embodiments, the magnitude proportional factor may be substantially smaller than the aforementioned ranges or about 1 (i.e. the size of the intake opening is the same as the exhaust opening). For example, in such cases the cross-sectional area of the exhaust opening(s) may be in the range of about 50% to about 150% (i.e. proportional factor of 0.5 and 1.5 respectively) the size of the cross-sectional area of the intake opening.

An exemplary exhaust controller 100, such as the one illustrated in FIGS. 1-7, may further comprise an adjustable connecter 105 operable to create an air-tight seal between the intake opening 101 and the pneumatic line 108. In some embodiments, the adjustable connector 105 may comprise a pipe fitting with hose clamps 109. In such embodiments, the adjustable connector may comprise an intake interface 106 and a pneumatic line interface 107 operable to interface with the intake opening 101 and the pneumatic line respectively. The intake interface may further comprise a hose clamp 109A, operable to adjust the shape/size of the intake interface to adjust the strength of the seal with the intake opening 101. Similarly, the pneumatic line interface may further comprise a hose clamp 109B, operable to adjust the shape/size of the intake interface to adjust the strength of the seal with the pneumatic line. In some embodiments the shape and size of both the intake interface 106 and pneumatic line interface 107 may coincide with the intake opening 101, having an elliptical or circular shape with a diameter in the range of about 0.5 in. to about 5 in. The adjustable connector 105 may be comprised of rubber, plastic, silicone, or any other material flexible enough to enable the connector 105 to adjust the size and shape (i.e., stretching and constricting) without compromising the integrity of the seal.

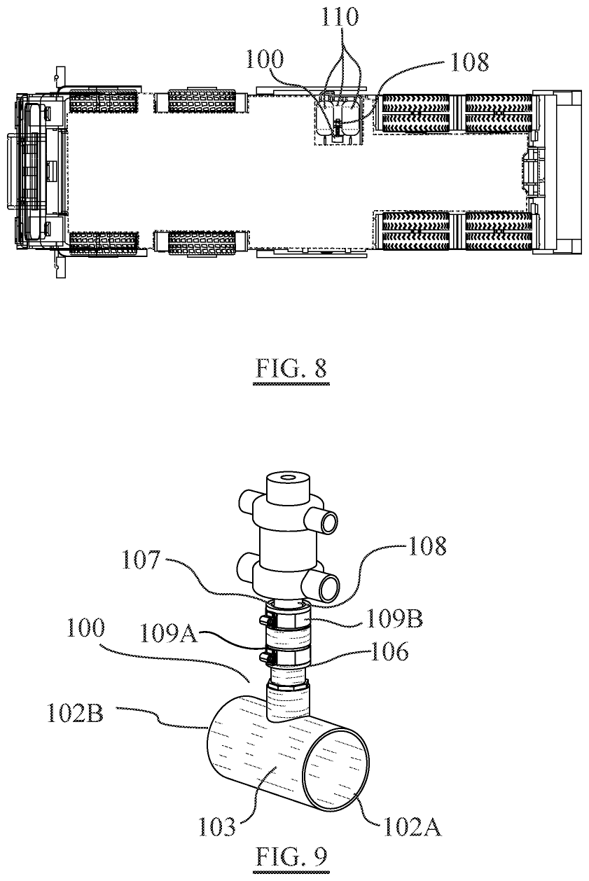

In some embodiments, the exhaust controller 100, may be operable to interface with any pneumatic line 108 of a vehicle's pneumatic system, including exhaust valves, hoses/tubes, and relays that may be part of an air compressor, air reservoir, air braking, or an air suspension system. For example, as shown in FIG. 8 and FIG. 9, the exhaust controller may form an air tight seal with the exhaust valve 108 located on the vehicle's air tank 110.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A device for controlling exhaust air from the pneumatic system of a vehicle comprising:
a. an intake opening operable to interface with a pneumatic line, receive compressed air via said pneumatic line, and direct it towards;
b. at least one exhaust opening operable to redirect said compressed air.

2. The device of claim 1, wherein said at least one exhaust opening comprises a first and second exhaust opening located on opposite sides of the device, such that said compressed air is redirected into two streams.

3. The device of claim 3, wherein said device comprises a hollow cylindrical body further comprising:
a. a first end corresponding with said first exhaust opening,
b. a second end corresponding with said second exhaust opening,
c. a hollow stem protruding from the surface of said cylindrical body comprising a base with an inferior opening located within said hollow cylindrical body and a superior opening at the peak of said hollow stem corresponding to said intake opening.

4. The device of claim 1, further comprising an adjustable connecter comprising intake interface and a pneumatic line interface operable adjust the seal between said intake opening and pneumatic line.

5. The device of claim 1, wherein said pneumatic line is a valve or airline hose of said pneumatic system.

6. The device of claim 5, wherein said pneumatic line is located on an air compressor, air tank, air braking, or on an air suspension system.

7. The device of claim 1, wherein said at least one exhaust opening has a cross-sectional area proportional to the cross-sectional area of said intake opening by a proportional factor.

8. The device of claim 7, wherein said the magnitude of said proportional factor is in the range such that the exhaust controller is operable to effectively neutralize the force of air exiting said exhaust opening

9. The device of claim 7, wherein said the magnitude of said proportional factor is in the range such that the exhaust controller is operable to provide a dusting effect that purges dust, debris, and other small particles from the internal components of said vehicle.

10. A device for controlling exhaust air from the pneumatic system of a vehicle comprising:
a. an intake opening operable to interface with a pneumatic line, receive compressed air via said pneumatic line, and further comprising an adjustable connecter.
b. at least one exhaust opening operable to redirect said compressed air away from a surface on which said vehicle is positioned.

11. The device of claim 10, wherein said device comprises a hollow cylindrical body further comprising:
a. a first end corresponding with said first exhaust opening,
b. a second end corresponding with said second exhaust opening,
c. a hollow stem protruding from the surface of said cylindrical body comprising a base with an inferior opening located within said hollow cylindrical body and a superior opening at the peak of said hollow stem corresponding to said intake opening.

12. The device of claim 10, wherein said adjustable connecter comprises intake interface and a pneumatic line interface operable adjust the seal between said intake opening and pneumatic line.

13. The device of claim 10, wherein said pneumatic line is a valve or airline hose of said pneumatic system.

14. The device of claim 13, wherein said pneumatic line is located on an air compressor, air tank, air braking, or on an air suspension system.

15. The device of claim 10, wherein the cross-sectional area of said at least one exhaust opening is proportional to said intake opening, and are in a range such that the exhaust controller is operable to effectively neutralize the force of air exiting said exhaust opening

16. The device of claim 15, wherein said intake opening has a cross-sectional area in the range of about 0.25 sq in. to about 25 sq in. and said at least one exhaust opening has a cross sectional area in the range of about 0.5 sq in. to about 125 sq in.

17. The device of claim 15, wherein said intake opening has a cross-sectional area in the range of about 0.5 sq in. to about 15 sq in. and said at least one exhaust opening has a cross sectional area in the range of about 1 sq in. to about 75 sq in.

18. The device of claim 15, wherein said intake opening has a cross-sectional area in the range of about 1 sq in. to about 5 sq in. and said at least one exhaust opening has a cross sectional area in the range of about 2 sq in. to about 25 sq in.

19. A method of directing exhaust air from a pneumatic system in a vehicle, comprising:
a. releasing air through a release valve of said pneumatic system and passing the air through an intake opening of an exhaust controller in fluid communication with said release valve;
b. redirecting the air along at least one redirection channel of said exhaust controller away from a surface on which said vehicle is positioned.

20. The method of claim 19, wherein said at least one redirection channel comprises a plurality of exhaust opening, such that said compressed air is redirected into a plurality of streams.
